(19) United States
(12) Patent Application Publication
(10) Pub. No.: US 2023/0320282 A1
(43) Pub. Date: Oct. 12, 2023

(54) SYSTEM AND METHOD FOR TRACKING BATCHES OF VEGETATION THROUGH DIFFERENT ZONES

(71) Applicant: Argus Control Systems Ltd., Surrey (CA)

(72) Inventor: Jason Richard George Stephens, North Vancouver (CA)

(21) Appl. No.: 18/133,678

(22) Filed: Apr. 12, 2023

Related U.S. Application Data
(60) Provisional application No. 63/330,049, filed on Apr. 12, 2022.

(51) Int. Cl. A01G 9/24; A01G 9/18

(52) U.S. Cl. CPC A01G 9/24; A01G 9/18; A01G 9/249; A01G 9/246

(57) ABSTRACT

A system for growing vegetation that includes a plurality of zones, each zone having environmental conditions that vary from environmental conditions in other zones, at least one zone sensor measuring environmental conditions in each zone, a local database operative to store sensor measurements from the zone sensors, a remote database operative to receive and to store a subset of the sensor measurements stored in the local database, and a remote computing device operatively connected to the remote database. The remote computing device operative to receive information regarding movements of batches of vegetation through the plurality of zones and, using the received information, associate sensor measurements of the environmental conditions the batch of vegetation is subjected to as it move through the zones. A timeline for a batch of vegetation can be created that indicates the environmental conditions the vegetation is subjected to moving through the zones.

### CROSS-REFERENCE TO RELATED APPLICATIONS

This patent application claims the benefit of U.S. Provisional Patent Application Ser. No. 63/330,049 filed on Apr. 12, 2022 and entitled “System and Method for Tracking Batches of Vegetation Through Different Zones”, the disclosure of which is hereby incorporated by reference herein in its entirety and made part of the present U.S. utility patent application for all purposes.

### BACKGROUND

The disclosed technology relates to systems, devices, and methods for tracking batches of vegetation through different predetermined zones; and more particularly to systems, devices, and methods for obtaining sensor measurements from different predetermined zones as the batches of vegetation are moved between different predetermined zones.

Vegetation that is grown commercially, such as a cannabis, is often grown on a large scale under very specifically controlled environmental conditions. Because this vegetation favors different environmental conditions at different stages of its maturity/development and takes up more space as the vegetation grows, there are often different zones with environmental conditions chosen for different stages of the vegetation's development/life cycle. For example, some environmental conditions may be more desirable when a type of vegetation is growing and other environmental conditions may be more desirable for when the vegetation has reached maturity and is flowering. Instead of having the vegetation in a single area and having the area change the environmental conditions for different stages in the life cycle of the vegetation, the vegetation is sometimes grouped into batches and these batches of vegetation are physically moved between different zones with different environmental conditions.

For example, when a batch of vegetation has grown to a desired size and it is entering a flowering stage, the batch of vegetation can be physically removed from a first zone, with environmental conditions more favorable for growth of the vegetation, and moved to a next zone, with environmental conditions maintained at levels that are more conducive for the vegetation in the batches to flower. However, while this allows users to grow multiple batches of vegetation and tailor zones to maintain a desired set of environmental conditions for a specific stage in the lifecycle of the vegetation, it causes complexity in tracking the various batches. First, there can be numerous zones with different environmental conditions which a batch of vegetation may move through before its life cycle is complete, with each zone subjecting the vegetation in the batches to potentially very different environmental conditions. Additionally, with a number of different batches, tracking the multiple batches moving through different zones and at different times makes it cumbersome to track and determine what environmental conditions a specific batch of vegetation was subjected to. In some carefully controlled systems, varying environmental conditions for the vegetation at different times in its development and for different lengths of time can have significant impact on the maturity of the vegetation and the yields obtained from such vegetation.

### SUMMARY

The following provides a summary of certain example implementations of the disclosed technology. This summary is not an extensive overview and is not intended to identify key or critical aspects or elements of the disclosed technology or to delineate its scope. However, it is to be understood that the use of indefinite articles in the language used to describe and claim the disclosed technology is not intended in any way to limit the described technology. Rather the use of “a” or “an” should be interpreted to mean “at least one” or “one or more”.

One implementation of the disclosed technology provides a system for growing vegetation. This system includes a plurality of zones, each zone being operative to hold at least one batch of vegetation and having one or more specific environmental conditions that vary from environmental conditions in other zones; at least one zone sensor measuring at least one environmental condition in each zone in the plurality of zones; at least one controller operatively connected to the plurality of zone sensors to receive sensor measurements from the plurality of zone sensors; a local database comprising at least one computer readable memory and operatively connected to the at least one controller, the local database operative to store sensor measurements from the plurality of zone sensors on the at least one computer readable memory of the local database; a remote database comprising at least one computer readable memory and operatively connected to the local database, the remote database operative to receive and to store a subset of the sensor measurements stored in the local database in the computer readable memory of the remote database; and a remote computing device operatively connected to the remote database. The remote computing device can be operative to receive information regarding movements of batches of vegetation through the plurality of zones and using the received information regarding movement of batches of vegetation through the plurality of zones, associate sensor measurements stored in the remote database with each batch of vegetation based on when the batch of vegetation was in zones in the plurality of zones.

Another implementation of the disclosed technology provides a method of tracking a batch of vegetation through a plurality of zones. This method includes creating a batch object, the batch object identifying the batch of vegetation and assigning the new batch object to a first zone from the plurality of zones the batch of vegetation is placed in; obtaining at least one environmental condition measurement from the first zone and associating the at least one environmental condition measurement from the first zone with the batch object; obtaining periodic at least one environmental condition measurements from the first zone and associating the obtained periodic at least one environmental conditional measurements with the batch object until a time the batch objected is assigned to a second zone indicating the batch of vegetation has been moved to the second zone; and obtaining periodic at least one environmental condition measurement from the second zone and associating the at least one environmental condition measurement from the second zone with the batch object.

It should be appreciated that all combinations of the foregoing concepts and additional concepts discussed in greater detail below (provided such concepts are not mutually inconsistent) are contemplated as being part of the technology disclosed herein and may be implemented to achieve the benefits as described herein. Additional features and aspects of the disclosed system, devices, and methods will become apparent to those of ordinary skill in the art upon reading and understanding the following detailed description of the example implementations. As will be appreciated by the skilled artisan, further implementations are possible without departing from the scope and spirit of what is disclosed herein. Accordingly, the descriptions provided herein are to be regarded as illustrative and not restrictive in nature.

### BRIEF DESCRIPTION OF THE DRAWINGS

The accompanying drawings, which are incorporated into and form a part of the specification, schematically illustrate one or more example implementations of the disclosed technology and, together with the general description given above and detailed description given below, serve to explain the principles of the disclosed subject matter, and wherein:

FIG. 1 is a schematic system diagram of an example system used to grow batches of vegetation in accordance with the disclosed technology;

FIG. 2 depicts an example data structure for storing sensor measurements;

FIG. 3 depicts an example data structure for storing batch information and associating the information with sensors measurements taken by sensor in different zones;

FIG. 4 depicts a screenshot of an example page of an example interface;

FIG. 5 is a flowchart depicting an example method for tracking and creating a timeline for a batch of vegetation as it moves through zones in an example system;

FIG. 6 depicts a screen shot of an example page of an example interface showing timelines of environmental conditions for a batch of vegetation;

FIG. 7 depicts a flowchart of an example method for creating a timeline for a batch of vegetation based on past movements of the batch of vegetation; and

FIG. 8 is a schematic illustration of an example remote computing device as used with the disclosed technology.

### DETAILED DESCRIPTION

Example implementations are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the disclosed technology. Accordingly, the following implementations are set forth without any loss of generality to, and without imposing limitations upon, the claimed subject matter.

The examples discussed herein are examples only and are provided to assist in the explanation of the apparatuses, devices, systems, and methods described herein. None of the features or components shown in the drawings or discussed below should be taken as required for any specific implementation of any of these the apparatuses, devices, systems or methods unless specifically designated as such. For ease of reading and clarity, certain components, modules, or methods may be described solely in connection with a specific Figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

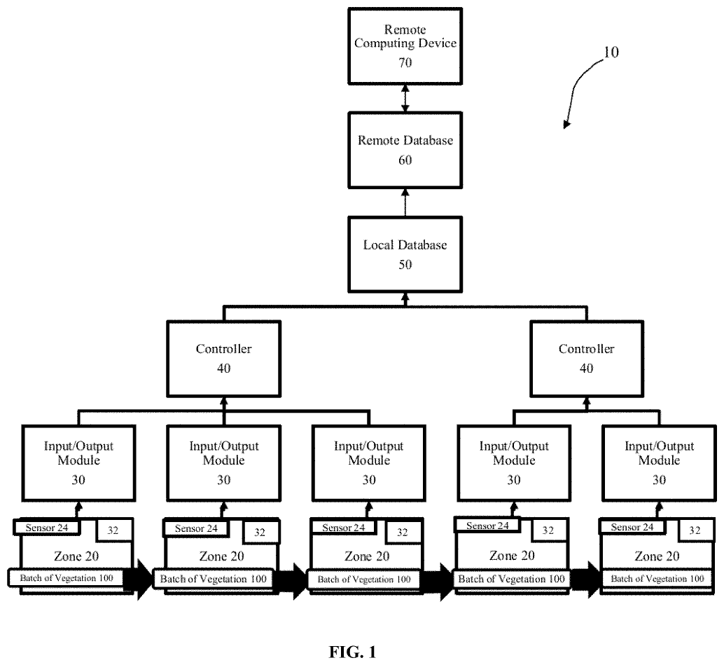

FIG. 1 illustrates a system diagram illustrating a system 10 for growing plants or other vegetation. The system 10 can include: a plurality of zones 20; a plurality of zone sensors 24; a plurality of input/output modules 30; one more controllers 40; a local database 50; a remote database 60; and a remote computing device 70.

The system 10 is used for growing and maturing vegetation. A number of batches of vegetation 100 are moved through different zones 20 in the system 10. The different zones 20 will typically have specific environmental conditions that are favorable for different periods during the growth of the vegetation in the batches of vegetation 100 so that a batch of vegetation 100 can be moved into a zone 20 in order to be subjected to environmental conditions that are suited for its current state of growth and then moved to a next zone 20 when the vegetation in the batch of vegetation 10 has entered another growth phase were different environmental conditions are more favorable for that next growth stage.

Each zone 20 is an area where one or more batches of vegetation 100 can be placed and are typically configured to control one or more environmental conditions in the zone 20. These environmental conditions can include: temperature; humidity; CO2; light; etc. Other conditions in the zones 20 can also be measured, such as nutrient irrigation, substrate data, etc. In one aspect, these zones 20 can be hermitic growth chambers for complete control of the environmental conditions in the zone 20 through the use of HVAC systems, humidifiers, light systems, etc. However, in other aspects, they could be rooms, greenhouses, areas of a room, outside fields, etc. Each zone 20 will typically have one or more specific environmental conditions that vary from the environmental conditions in other zones 20; making the one or more environmental condition in the zone 20 unique. The environmental conditions in a zone 20 would typically be chosen because they are desirable for a specific stage in the growth of vegetation that is in the batches of vegetation 100. Batches of vegetation 100 containing vegetation in the stage of growth that one zone 20 has desirable environmental conditions for, can be placed in this zone 20 until the vegetation in the batch of vegetation 100 reaches another stage of growth at which time the batch of vegetation 100 can be moved to another zone 20 that has more favorable environmental conditions for this next stage of growth. In this manner, the different zones 20 in the system 10 can provide different growing conditions for vegetation in the batches of vegetation 100 at different stages in the growth/maturity of the vegetation that will be grown in the system 10.

The zones 20 can also be used for other steps relating to the vegetation in the batches of vegetation 100 and not necessarily during the growth of the vegetation. For example, if the vegetation being grown in the batches of vegetation 100 is cannabis, the system 10 may have one or more zones 20 for cloning of the cannabis where one or more environmental conditions in the zone 20 are controlled to make the zone 20 conducive for cloning the cannabis. The system 10 may also have one or more zones 20 with one or more controlled environment conditions that are conducive for the cannabis to vegetate, and one or more zones 20 with one or more controlled environment conditions that are conducive for the cannabis to flower. For post-growth stages, the system 10 could have one or more zones 20 with one or more controlled environment conditions that are conducive for drying the cannabis and one or more zones 20 with one or more controlled environment conditions that are conducive for curing the cannabis.

If the vegetation is another type of vegetation grown from seeds, it may have one or more zones 20 with one or more environmental conditions that are conducive for causing the seed to sprout and one or more zones 20 with environmental conditions controlled to make it conducive for the seedlings to grow.

Additionally, the vegetation being grown in the system 10 may be more than one type of vegetation or more than one cultivar where the different types/cultivars develop better with different environmental conditions at different stages in their growth stages than other types/cultivars. A number of the zones 10 may be directed at the same stage of the development of the vegetation, but have one or more environmental conditions that differ from other zones 20 for different types/cultivars of the vegetation. Alternatively, some types/cultivars of the vegetation may benefit from being in certain zones 20 longer than other types/cultivars. For example, one type/cultivar of the vegetation may not have a lot of benefit from being in a zone 20 directed to the flowering stage of the vegetation for more than 3 days while, while another cultivar of vegetation may benefit from being in the same zone 20 for 5 days or more. Different batches of vegetation 100 can be kept in the same zone 20 for differ periods of time.

Each zone 20 can have one or more sensors 24 in the zone to measure one or more environmental conditions in the zone 20. For example, in a specific zone there could be a plurality of sensors 24, including a temperature sensor, a humidity sensor, a CO2 sensor, a light sensor, etc., for measuring different environmental conditions in the zone. There could also be other sensors related to irrigation, such as a temperature sensor at the pump, an electrical conducting sensor at the pump, a PH sensor at the pump, a flow rate sensor at the pump, a temperature senor in the substrate, an electrical conductivity in the substrate, a PH sensor in the substrate, a moisture content sensor in the substrate, a temperature sensor in the leachate, electrical conductivity sensor in the leachate, a PH sensor in the leachate and a volume sensor in the leachate. The sensors 24 can also be cameras, weigh scales, etc.

In one aspect, there may be more than one sensor 24 in a zone 20 measuring a specific environmental condition. This could be to take measurements of the environmental condition at different locations in the zone 20 or to get a more accurate reading of the environmental condition in the zone 20 by taking a number of different measurements and averaging them together.

One or more controllers 40 can be present in the system 10 operatively connected to the sensors 24 in the zones 20. The controller(s) 40 can receive sensor measurements from the sensors 24 in the different zones 20 and store these sensor measurements in the local database 50. The controller(s) 40 can also uses the received sensor measurements from the different zones 20 to control the environmental conditions in the different zones 20.

In one aspect, the controller(s) 40 can be connected to the sensors 24 and equipment 32 associated with the zones 20 through input/output modules 30. The plurality of input/output modules 30 can be connected to the sensors 24 associated with the different zones 20 to receive sensor measurements from the sensors 24 as input and communicate these received sensor measurements to the controller(s). The controller(s) 40 can also transmit signals to the various input/output modules 30 which in turn the input/output module 30 can transmit these signals to actuators to control equipment 32 in the zones 20 and thereby control or alter one or more environmental conditions in the zone 20 using this equipment 32.

The actuators can be used to control a variety of equipment 32 associated with the different zones 20 including furnaces, air conditioning units, air vents, fans, light systems, misters, CO₂ injectors, etc.

For example, a sensor 24 in a zone 20 that is measuring temperature in that zone 20 can take a temperature measurement and transmit this temperature measurement to the input/output module 30. The input/output module 30 can, in turn, transmit this temperature measurement to the at least one controller 40 along with an indicator of what sensor 24 took the temperature measurement and/or what zone 20 the temperature measurement was taken in. The controller 40 may then determine that the temperature in that zone 20 is too low and transmit a signal back to the input/output controller 30, which in turn will transmit a signal to an HVAC system for that zone 20 to supply heat to the zone 20 to raise the temperature in the zone 20 to a desired temperature.

In addition to the controller 40 being used to operate equipment 32 associated with the different zones 20 to control one or more environmental conditions in the zones 20, the controller 40 can be used to record data in the form of information about the environmental information in the zones 20. Sensor measurements made by the sensors 24 associated with the different zones 20 can be transmitted to the controller 40, such as through the input/output modules 30, and the controller 40 can then transmit these sensor measurements to the local database 50 for storage. The controller 40 can not only use these sensor measurements to control the environmental conditions in the different zones 20, but it can store these sensor measurements.

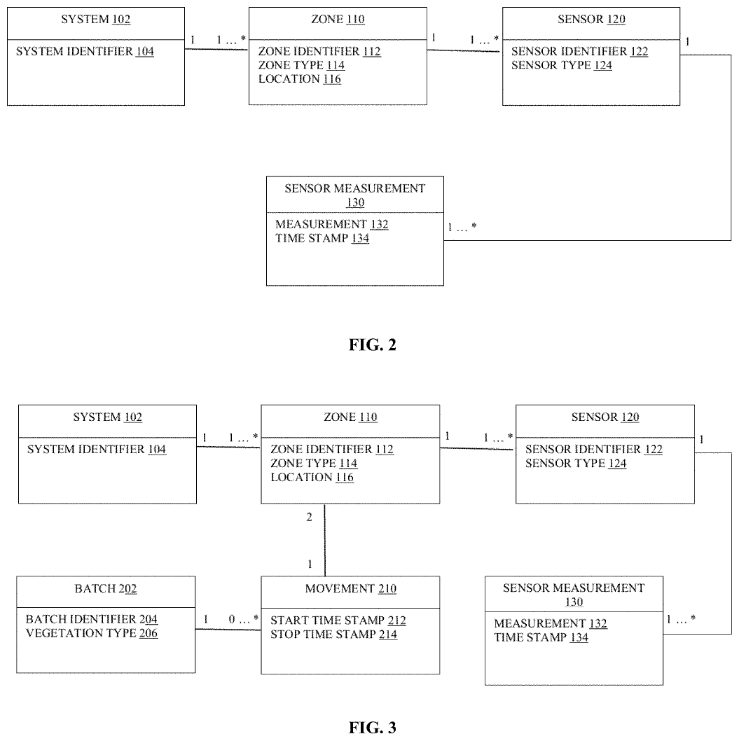

The local database 50 can have at least one computer readable memory and can be used by the controller 40 to store sensor measurements from the sensors 24 associated with different zones 20 and other information in a data structure. FIG. 2 illustrates a data structure in one aspect that may be used to store sensor information from the sensors 24 associated with the zones 20 in the system 10 shown in FIG. 1.

The data structure can have a system object 102 that corresponds to the system 10 shown in FIG. 1. The system object 102 can have a system identifier field 104 which can contain information identifying the system 10. The system objection 102 can also have additional fields to contain other information about the system 10 that may be desirable to have.

The system objection 102 can be associated with one or more zone objects 110 where each zone object 110 corresponds to one of the zones 20 in the system 10 shown in FIG. 1. Each zone object 110 can have a zone identifier field 112 which can contain an identifier that can be used to identify the zone 20 in the system 10 that the zone object 110 corresponds to, and a zone type field 114 which can contain information on the type of zone (i.e. vegetative, flower room, curing, etc.) that the zone 20 in the system 10 that the zone object 110 corresponds to is. Each zone object 110 can also contain additional information such as a location field 116 indicating where the zone 20 in the system 10 the zone object 110 corresponds to is located, etc.

Each zone object 110 can be associated with one or more sensor objects 120 where each sensor object 120 can correspond to a sensor 24 taking measurements in the zone 20 that the zone object 110 that is associated with the sensor object 120 corresponds to. Each sensor object 120 can have a sensor identifier field 122 which can contain information identifying the sensor 24 associated with the sensor object 120; a sensor type field 124 storing information identifying the type of sensor the corresponding sensor 24 is (i.e. temperature sensor, a humidity sensor, a CO2 sensor, a light sensor, etc.).

Each sensor object 120 can be associated with a plurality of measurement objects 130 where each measurement object 130 can contain a measurement field 132 for storing a measurement from the sensor 24 associated with the sensor object 120 and a time stamp field 134 contain a time the sensor measurement stored in the sensor measurement field was taken.

Referring again to FIG. 1, as the sensors 24 in the system 10 take sensor measurements of environmental conditions in the zones 20 the sensors 24 are provided in, these sensor measurements can be transmitted to the input/output modules 30 and from the input/output modules 30 to the controller(s) 40. The controller(s) 40 can transmit the sensor measurements and a time stamp indicating when the sensor measurement was taken, along with an identifier of the sensor, to the local database 50 where the local database can create a sensor measurement object 130 for the sensor measurement to store the sensor measurement in the measurement field 132 and the time stamp in the time stamp field 134. This sensor measurement objection 130 will be associated with a sensor object 120 which will in turn be associated with a zone objection 110. The remote database 60, such as cloud database, can be provided, having at least one computer readable memory, where data from the local database 50 can be uploaded to the remote database 60 for access by remote computing devices 70. The data stored in the remote database 60 can be a subset of the data in the local database 50 with less sensor measurements stored than in the local database 50.

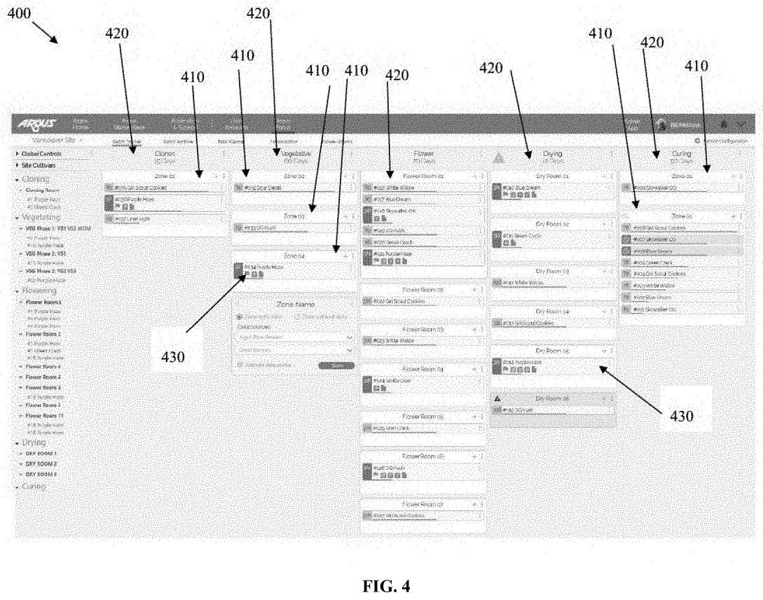

FIG. 3 illustrates a data structure in one aspect that can be stored in the remote database 60 and can be used to store batch information about batches of vegetation 100 in the system 10. This batch information can also be used to associate batches with sensor measurements taken with sensors 24 in the zones 20 in the system 10 shown in FIG. 1.

The data structure shown in FIG. 3 and stored in the remote database 60 can have a number of objects uploaded to it from the local database 50, including the system object 102, the zone objects 110 and the sensor objects 120, mirroring the same objects in the local database 50. Sensor measurement objects 130 would also be uploaded from the local database 50, but only a subset of the sensor measurement objects 130 may be uploaded to the remote database 60 so the number of sensor measurement objects 130 stored in the remote database 60, although corresponding to sensor measurement objects 130 in the local database 50, may not mirror the number of sensor measurement objects 130 in the local database 50.

Along with these objects, the remote database 60 may also store a plurality of batch objects 202. Each batch object 202 can be associated with a batch of vegetation 100 moving through the zones 20 in the system 10. Each batch object 202 can include: a batch identifier field 204 that can be used to identify the batch of vegetation 100 in the system 10 the batch object 202 is associated with; and, a vegetation type field 206, indicating the type of vegetation and/or species of the vegetation.

Each batch object 204 can also be associated with 0 to a plurality of movement objects 210 where each movement object 210 is associate with two zone objects 110; a zone object 110 corresponding to the zone 20 that the batch of vegetation 100 was moved from and a zone object 110 corresponding to the zone 20 that the batch of vegetation 100 was moved into. The movement object 210 can be created when the batch of vegetation 100, corresponding to the batch object 240, is moved into a zone 20 in the system 10 and the first zone object 110 associated with the movement object 210 can correspond to the zone 20 in the system 10 the batch of vegetation 100 is moved from and the second zone object 110 associated with the movement object 210 can correspond to the zone 20 in the system 10 the back to vegetation 100 is moved into. This movement object 210 can include: a start time stamp field 212 for storing a time the batch of vegetation 100 is moved into the zone 20 in the system 10; and, a stop time stamp field 214 for storing a time the batch of vegetation 100 is moved out of the zone 20 in the system 10.

In this manner, each batch object 202 can use its current associated movement object 210 (i.e. the one that has a start time, but not end time) indicating the batch of vegetation 100 corresponding to the batch object 202 is still in the zone 20 corresponding to the zone object 110 the movement object 210 is associate with, to obtain sensor measurements from the senor measurement objects 130 associated with the sensor objects 120 that are associated with the zone object 110.

The remote computing device 70 can be used to interface with the remote database 60 and used to track specific batches of vegetation through the different zones 20 in the system 10. The remote computing device 70 can be a remote computer, a mobile device such as a smart phone or tablet, etc.

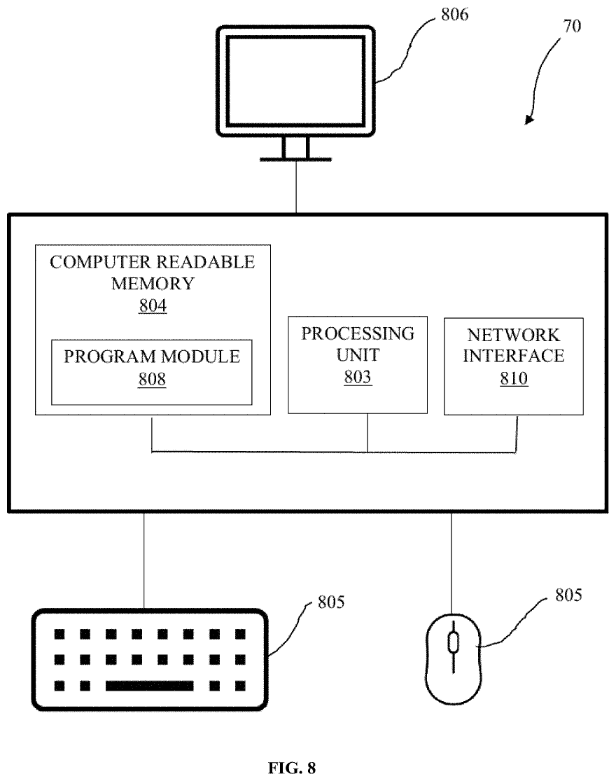

FIG. 8 illustrates the remote computing device 70, in one aspect. The remote computing device 70 can comprises: at least one processing unit 803; a computer readable memory 804; at least one input device 805; a display device 806; a program module 808 and a network interface 810. The processing unit 803 can be any processor that is typically known in the art with the capacity to run the provided methods and is operatively coupled to the computer readable memory 804 through a system bus. In some circumstances the remote computing device 70 may contain more than one processing units 803. The computer readable memory 804 is operative to store data and can be any storage device that is known in the art, such as a local hard-disk, etc. and can include local memory employed during actual execution of the program code, bulk storage, and cache memories for providing temporary storage. Additionally, the computer readable memory 804 can be a database that is external to the remote computing device 70 but operatively coupled to the remote computing device 70. The input device 805 can be any suitable device suitable for inputting data into the remote computing device 70, such as a keyboard, mouse or data port such as a network connection and is operatively coupled to the processing unit 803 and operative to allow the processing unit 803 to receive information from the input device 805. The display device 806 can be a monitor, etc. and operative to display information. The display device 106 could be a stand-alone screen or if the remote computing device 70 is a mobile device, the display device 106 could be integrated into a casing containing the processing unit 103 and the computer readable memory 104. The program module 108 is stored in the computer readable memory 104 and operative to provide instructions to processing unit 103 and the processing unit 103 is responsive to the instructions from the program module 108.

The network interface 810 allows the remote computing device 70 to be connected to a computer network such as an intranet or the internet. This network interface 110 could be an Ethernet card, modem or other line based network system or a wireless connection such as 802.11, or other suitable network.

Although other internal components of the remote computing device 70 are not illustrated, it will be understood by those of ordinary skill in the art that only the components of the remote computing device 70 necessary for an understanding of the present invention are illustrated and that many more components and interconnections between them are well known and can be used.

FIG. 4 is a screenshot of a first screen of the interface 400 that can be displayed on the display device 106 of the remote computing device 70 is shown. The interface 400 could be provided by software resident on the remote computing device 70 or it could be a website accessed through a web browser resident on the remote computing device 70. The interface 400 can have: a number of zone identifiers 410; a number of zone type identifiers 420; and a number of batch identifiers 430.

Each zone identifier 410 shown in the interface 400 can correspond to a zone 20 in the system 10 and the zone record 110 associated with that zone 20. The zone identifiers 410 shown in FIG. 4 are grouped under zone type identifier 420.

The zone type identifiers 420 can also be provided on the interface 400 and each zone type identifier 420 can correspond to a type of zone in the system 10. The system 10 may have a number of different types of zone types where one or more of the zones 20 in the system 10 correspond to one of these zone types. In some cases, the system 10 may have more than one zone 20 with environmental conditions directed at the same stage of growth for the vegetation in the batches of vegetation 100. For example, in FIG. 4 there are three (3) zone identifiers 410 grouped under the zone type identifier 420 labeled “vegetative”, but seven (7) zone identifiers 410 grouped under the zone type identifier 420 labelled “flower”. This is because there are more zones 20 in the system 10 directed to the flower development stage of the vegetation in the batches of vegetation 100 than there are zones 20 in the system 10 directed to the vegetative development stage of the vegetation. The different numbers of zones 20 in the system 10 with environmental conditions being maintained for different stages of development of the vegetation could be a result of a number of factors. The size of the zone 20 could be a factor. Depending on how many batches of vegetation 100 can physically fit in the zone 20, if some types of zones are smaller than other types of zones, more zones may be needed for one type of zone. They length of time the batches of vegetation 100 will spend in a type of zone can also be a factor, with zones 20 directed at longer development stages of the vegetation than other zones 20 possibly needing more zones to accommodate the batches of vegetation 100 in them longer than other zones types.

The zone identifiers 410 can be visually associated with a zone type identifier 420 in the interface 400 to indicate to a user the type of zone each zone 20 represented by a zone identifier 410 is. In the interface 400 shown in FIG. 4, this is done by the zone identifiers 410 being visually represented below the zone type identifier 420 indicating what type of zone 20 it is. The zone type identifiers 420 can correspond to the zone type 114 stored in the zone object 110. The interface 400 can also include a number of batch identifiers 430. These batch identifiers 430 can be associated with a specific batch of vegetation 100 moving through the different zones 20 in the system 10. The batch identifiers 430 can also correspond to a batch object 202 in the remote database 60.

The batch identifiers 430 can be visually associated with a zone identifier 410 in the interface 400 to indicate in which zone 20 in the system 10 a batch of vegetation 100 corresponding to the batch identifier 430 is located. In the interface 400 shown in FIG. 4 this visual representation is shown by the zone identifier 410 comprising a box and the batch identifier 410 being located within this box of the zone identifier 410.

The interface 400 can allow a user to track batches of vegetation 100 as they move through the zones 20 in the system 10. In one aspect, a user can drag and drop a batch identifier 430, representing a batch of vegetation 100 in the system 10, into the zone identifier 410 corresponding to the zone 20 in the system 10 that the batch of vegetation 100 has been moved into. For example, when a batch of vegetation 100 is moved into a different zone 20 in the system 10, because the vegetation in the batch of vegetation 100 has finished the development stage that zone 20 is being used for and is now being moved into a next zone 20 better suited for its current stage of development, a user can drag and drop the batch identifier 430 on the interface 430, that corresponds to the batch of vegetation 100 in the system 10, into the zone identifier 410 that corresponds with the zone 20 in the system 10 that the batch of vegetation 100 has been moved to. When this batch of vegetation 100 is finished in that zone 20 in the system 10 and is moved into the next zone 20 (typically a number of days after it has been placed in that zone and depending on what stage of development the zone is for), a user can select the batch identifier 430 in the interface 400 that corresponds to the batch of vegetation 100 in the system 10 and can drag and drop the batch identifier 430 from the zone identifier 410 the batch identifier 430 is currently in to the zone identifier 410 that corresponds to the zone 20 in the system 10 to which batch of vegetation 100 has been moved.

When the batch identifier 430 is moved into this next zone identifier 430, the batch object 292 corresponding to the batch of vegetation 100 and the batch identifier 430 can be updated with an association to a new movement object 210 which in turn is associated with the zone object 110 corresponding to the zone 20 in the system 10 the batch of vegetation 100 was previously in, and associated with the zone object 100 corresponding to the next zone 20 in the system 10, and a time, indicating when the batch identifier 430 was moved into the next zone identifier 410 in the interface 400 can be saved in the start time stamp field 212 in the movement object 210.

When the batch identifier 430 is moved into a next zone identifier 410, the movement object 210 can take the time the batch identifier 430 was moved into this next zone identifier 410 and save it into the stop time stamp field 214 of the movement object 210 to indicate when the batch of vegetation 100 associated with the batch object 202 left the zone 20 in the system 10 the zone object 110, that is associated with the movement object 210, corresponds to. This will indicate that batch of vegetation 100 is no longer in the zone 20. A new movement object 210 can be created associated with the batch object 202, the zone object 110 corresponding to the previous zone 20 in the system 10 the batch of vegetation 100 was in, and the zone object 110 corresponding to the next zone 20 in the system 10 the batch of vegetation 100 has been moved to. The time of this movement can be placed in the start time stamp field 212 of this new movement object 210.

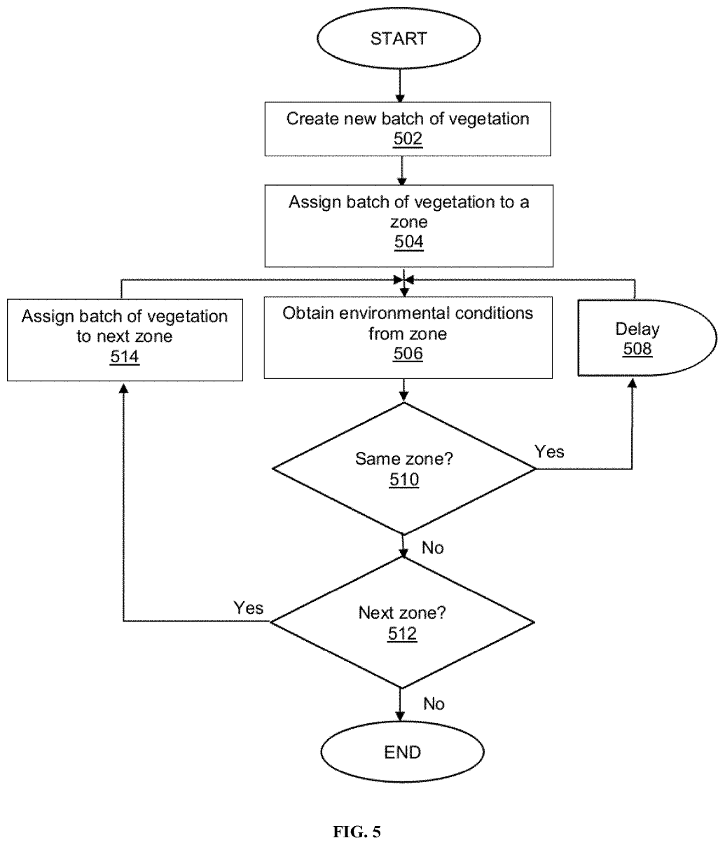

The movement of the batch identifiers 430 from one zone identifier 410 to a next zone identifier 410 on the interface 410 can be used create a timeline of one or more environmental conditions a batch of vegetation 100 is subjected to as it moves through different zones 20 in the system 10 and the vegetation in the batch of vegetation 100 is developing and maturing. Referring to FIG. 5, a flowchart of a method for tracking and creating a timeline for a batch of vegetation is illustrated.

The method can start and at step 502, with the user creating a new batch objected for a new batch of vegetation 100. Referring to FIG. 4, a user can create a new batch identifier 430 on the interface 400 and provide an identifier (i.e. a name) for the batch of vegetation 100, and indicate the type of vegetation making up the batch of vegetation 100. The creation of a new batch identifier 430 on the interface 400 can cause the interface 400 to request a new batch object 202 be created on the remote database 60, see FIG. 3, and the identifier entered by the user for the batch identifier 430 can be entered into the batch identifier field 204 for the new batch object 202 and the type of vegetation entered by the user can be entered into the batch type field 206.

Referring again to FIG. 5, the batch of vegetation 100 can be assigned to a first zone 20 at step 504. This assigned zone 20 will be the first zone 20 the batch of vegetation 100 is placed in the system 10 shown in FIG. 1. For the interface 400 shown in FIG. 4, this step 504 can occur when a user moves a batch identifier 430 into a first zone identifier 410 or creates a batch identifier in a first zone identifier 410 corresponding to the batch of vegetation 100 being placed in a first zone 20 in the system 10.

The details of the zone identifier 410 and the time the batch identifier 430, corresponding to the batch of vegetation 100 in the system 10, was placed in the zone identifier 410 can be used to create a movement object 210. The zone identifier 410 can be used to associate this new movement record 210 with the zone object 110 corresponding to the previous zone 20 in the system 10 and associate the movement record 210 with the zone object 110 corresponding to the new zone 20. The time the batch identifier 430 was placed in the zone identifier 410 can be inserted in the start time stamp field 212 of this new movement object 210 to indicate when the batch of vegetation 100 was moved into the first zone 20 in the system 10.

After step 504, the method can move onto step 506 and obtain one or more environmental condition measurements for the zone 20 the batch of vegetation 100 is in. Referring to FIG. 3, the next zone object 110, associated with the movement object 210 that is associated with the batch object 202, can be determined. From this zone object 110, the sensor objects 120 associated with this zone object 110 can be determined and the current sensor measurement object 130 associated with each sensor object 120 associated with the zone object 110 can be obtained. A sensor measurement corresponding to a measurement made by one of the sensor 24 in the zone 20 in the system 10 corresponding to the zone object 110 can be stored in the measurement field 132 of each sensor measurement object 130. A sensor measurement for each sensor 24 in the zone 20 in the system 10 can be obtained using the sensor object 120 that corresponds to the sensor 24. For example, if the zone 20 has a sensor 24 for measuring temperature and a sensor 24 for measuring light, at step 506 the method can obtain a temperature measurement and a light measurement.

The method can repeat step 506, after a delay at step 508, until the batch of vegetation 100 is moved to a next zone 20 at step 510. While the batch of vegetation 100 is still in the same zone 20 in the system 10 and the batch identifier 430 corresponding to that batch of vegetation 100 is still shown in the zone identifier 410 corresponding to the zone 20 in the system, the method can wait for a time delay at step 508 and then obtain another set of sensor measurements from the zone 20 after the time delay.

The sensor measurement can be obtained at step 506 again by obtaining the measurements from the sensor measurement objects 130 associated with the sensor objects 120 that are in turn associated with the zone object 110 corresponding to the zone 20 in the system 10 the batch of vegetation 100 is in.

This time delay can be used to obtain sensor measurements periodically throughout a day and the amount of time in the time delay can be based on the frequency of sensor measurements desired. For example, if only daily sensor measurements are required, the time delay at step 510 may be 24 hour, however, if sensor measurements are desired more often, this time delay can be shorter. For example, if the time delay at step 508 is 4 hours, sensor measurements may be obtained at step 508 ever 4 hours until the batch of vegetation 100 is moved to the next zone 20.

Steps 506 and 508 can be repeated until, at step 510, the batch of vegetation 100 is moved into the next zone 20 in the system 10. The method can move onto step 512 and determine if there is a next zone and, if so, the method can proceed to move onto step 514 and the batch of vegetation 100 can be assigned to the next zone 20 it is moved into in the system 10. For the interface 400 shown in FIG. 4, this can occur when a user drags and drops the batch identifier 430 corresponding to the batch of vegetation 100 into a new zone identifier 410 corresponding to the next zone 20 the batch of vegetation 100 has been moved into in the system 10.

At step 514 of the method the zone identifier 410 and the time the batch identifier 430 was moved to the zone identifier 410 can be used to update the data structure in the remote database 60. A new movement object 210 can be created associated with the existing batch object 202 corresponding to the batch of vegetation 100 in the system 20 that has been moved into the next zone 20. The zone identifier 410 the batch identifier 430 was moved into can be used to associate this new movement record 210 with the zone object 110 corresponding to the previous zone 20 the batch of vegetation 100 was in and associate this new movement record 210 with the next zone 20 in the system 10 the batch of vegetation 100 was moved into. The time the batch identifier 430 was placed in this next zone identifier 410 can be inserted in the start time stamp field 212 of this new movement object 210 to indicate when the batch of vegetation 100 was moved into the next zone 20 in the system 10.

After step 514 and the batch of vegetation 100 has been assigned to the next zone 20 in the system 10, the method can move back to step 506 and obtain one or more environmental condition measurements for the next zone 20 the batch of vegetation 100 has been moved to in the system 10. Referring to FIG. 3, the zone object 110, associated with this new movement object 210 that is associated with the batch object 202, can be determined. From this zone object 110, the sensor objects 120 associated with this zone object 110 can be determined and the current sensor measurement object 130 associated with each sensor object 120 that is associated with the zone object 110 can be obtained. A sensor measurement corresponding to a measurement made by one of the sensor 24 in the zone 20 in the system 10 corresponding to the zone object 110 can be stored in the measurement field 132 of each sensor measurement object 130. A sensor measurement for each sensor 24 in the zone 20 in the system 10 can be obtained using the sensor object 120 that corresponds to the sensor 24.

The method can repeat step 506, after the delay at step 510, for this next zone 20 until the batch of vegetation 100 is moved to another zone 20 and the batch identifier 430 is associated with the next zone identifier 410, associated with that next zone 20, in the interface 400 shown in FIG. 4. The method can repeat steps 506 and 508 while the batch identifier 430 remains associated with this next zone identifier 410; obtaining sensor measurements from the sensor 24 in the zone 20 in the system 10.

The method can continue this, repeating steps 506 and 510 for each zone 20 in the system 10 the batch of vegetation 10 is placed in and obtaining sensor measurements periodically from the sensor 24 in the zone 20, thereby creating a timeline of the environmental conditions the batch of vegetation 100 is subjected to as the batch of vegetation 100 moves through different zone 20 in the system 10.

When the batch of vegetation 100 is moved out of the last zone 20 and the batch identifier 430 in the interface 400 is disassociated with the last zone identifier 410, the method can move determine the batch of vegetation 100 is no longer in the same zone at step 510 and that there is no next zone 20 at step 512 and the method can end. At this point, there should be a complete timeline of the environmental conditions the batch of vegetation 100 was subjected to as it moved through the different zones 20 in the system 10 based on sensor measurements from the sensors 24 in each zone 20.

FIG. 6 shows a screen shot of another interface 600 displaying the timelines of the environmental conditions a batch of vegetation 100 is subjected to over time as it moves through different zones 20 in the system 10 shown in FIG. 1. The interface 600 shows a series of graphs 610 where each graph displays an environmental condition the batch of vegetation 100 the interface 600 is for is subjected to, even as it is moved between different zones 20 in the system 10. The interface 600 can be displayed on the display device 106 of the remote computing device 70. Stitch lines 620 can indicate times when a batch of vegetation 100 was moved from one zone 20 to a next zone 20 in the system 10. The different graphs 610 graph: temperature vs. time; humidity vs. time; CO2 concentration vs. time; light vs. time; pressure vs. time; and a number of conditions vs. time. In a further aspect, graphs for vapour-pressure deficit (VPD) and/or daily light integral (DLI) could be shown on interface 600. The information for the timelines shown in FIG. 6 could be obtained using the method illustrated in FIG. 5.

While the method shown in FIG. 5 gathers measurements of the environmental conditions a batch of vegetation 10 is subjected to in more or less real time as the batch of vegetation 10 spends time in different zones 20 in the system 10, in some cases a user may want to create a timeline of environmental conditions a batch of vegetation 100 has been subjected to in the past. This could be because they missed the batch of vegetation 100 being moved to a next zone 20 in the system 10 until some time had passed since the move, they did not assign the batch identifier 430, corresponding to the batch of vegetation 100 in the system 100, to the next zone identifier 410, corresponding to the zone 20 the batch of vegetation 100 was moved to until sometime after the batch of vegetation 100 had been moved to the next zone 20, they made a mistake and moved the batch identifier 430 to the to the wrong zone identifier 410 corresponding to a zone 20 other than the zone 20 the batch of vegetation 100 was moved into, an operator wants to start tracking batches of vegetation 100 in the system 100 that are already moving through the system 100 and want to obtain the historical data for these batches of vegetation 100, etc.

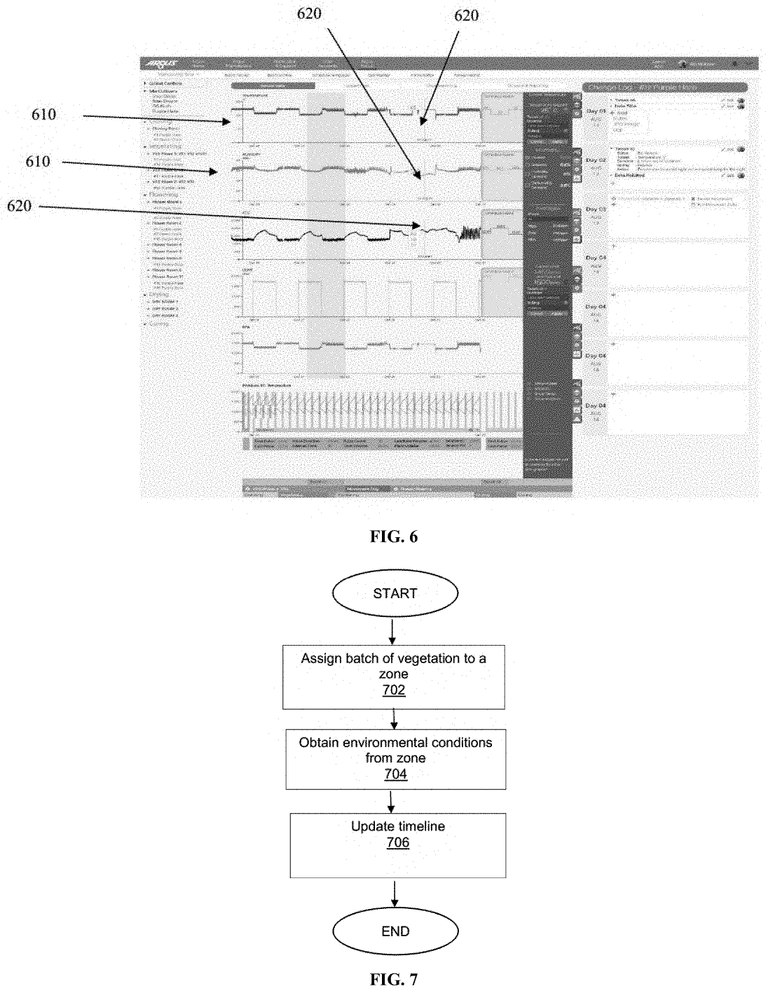

FIG. 7 illustrates a flowchart of a method for creating a timeline for a batch of vegetation based on past movements of the batch of vegetation. The method can start and at step 702, with the user assigning a batch of vegetation 100 to a zone 20 in the system 100. Referring to FIG. 4, a user can move a batch identifier 430 on the interface 400 into a first zone identifier 410 and input the start time the batch of vegetation 100 corresponding to the batch identifier 430 was moved into the zone 20 in the system 100 corresponding to the zone identifier 410. If the batch of vegetation 100 has been moved out of this zone 20 in the past, the user can also enter the stop time indicating when the batch of vegetation 100 corresponding to the batch identifier 410 was moved out of the zone 20 corresponding to the zone identifier 410.

Referring to FIG. 3, the details of the zone identifier 410 and the time the batch identifier 430 was placed in the zone identifier 410 can be used to create a new movement object 210, if a movement object 210 for the movement of the batch of vegetation 100 between the zones 20 does not exist, or to update the existing movement object 210. If a movement object 210 does not exist because the user is moving the zone identifier 410 to a new zone identifier 410, the zone identifier 410 can be used to create a new movement record 210 and associate this new movement record 210 with the zone object 110 corresponding to the previous zone 20 in the system 10 and associate the movement record 210 with the zone object 110 corresponding to the new zone 20. The start time entered into the batch identifier 430 for when the batch of vegetation 100 was placed in the zone 20 in the system 10, can be inserted in the start time stamp field 212 of this new movement object 210 to indicate when the batch of vegetation 100 was moved into the first zone 20 in the system 10. If a stop time was entered, this stop time can be inserted in the stop time stamp field 214 of this new movement object 210 to indicate when the batch of vegetation 100 was moved out of the zone 20 in the system 10.

If a movement object 210 does exist, because the user is simply changing a start time for when the batch of vegetation 100 was moved into the zone 20 in the system 10 or a stop time for when the batch of vegetation 100 was moved out of the zone 20 in the system 10, the existing movement object 210 can be updated. The altered start time entered into the batch identifier 430 for when the batch of vegetation 100 was placed in the zone 20 in the system 100, can be inserted in the start time stamp field 212 of this existing movement object 210 and/or the altered stop time can be inserted in the stop time stamp field 214 of this existing movement object 210 to indicate when the batch of vegetation 100 was moved out of the zone 20 in the system 10.

After step 702, the method can move onto step 704 and obtain the environmental condition measurements for the zone 20 the batch of vegetation 100 was. Referring to FIG. 3, the new or updated movement object 210 that is associated with the batch object 202, can be used to determine when the batch of vegetation 100 was first placed in the zone 20 corresponding to the zone object 110 associated with the movement object 210 using the start time stamp field 212 of this movement object. When the batch of vegetation 100 was moved out of the zone 20 (if it has been moved out of the zone 20) can be determined using the stop time stamp field 214 of the movement object. From the associated zone object 110, the sensor objects 120 associated with this zone object 110 can be determined and the sensor measurement objects 130 associated with each sensor object 120 associated with the zone object 110 can be obtained for the time between the start time in the start time stamp field 212 of the movement object 210 and the stop time in the stop time stamp field 214 of the movement object (if the batch of vegetation 100 has been moved out of the zone 2). The sensor measurements stored in the measurement fields 132 of these sensor measurement objects 130 can be obtained. Sensor measurements for each sensor 24 in the zone 20 in the system 10 can be obtained between the start time when the batch of vegetation 100 was placed in the zone 20 and the stop time when the batch of vegetation 100 was moved out of the zone 20 at step 704.

The method can then move onto step 706 and obtain any sensor measurements from previous or later zones 20 in the system 10. If a start time for when a batch of vegetation 100 has been moved later in time, the method can obtain the sensor measurements from the previous zone 20 for this change in time. If a stop time for when a batch of vegetation 100 has been moved back in time, the method can obtain the sensor measurements for the next zone 20 for this change in time.

When the sensor measurements have been obtained at step 704 for the time period the batch of vegetation 100 was in the zone 20 in the system 10, the method can move onto step 708 and update the timeline. The newly obtained sensor measurements obtained at step 704 can be used to replace any sensor measurements corresponding to these changes in the timeline and any new stitch lines 620 can be added to indicate where in the timeline a batch of vegetation 100 was moved to another zone 20 in the system 10.

All literature and similar material cited in this application, including, but not limited to, patents, patent applications, articles, books, treatises, and web pages, regardless of the format of such literature and similar materials, are expressly incorporated by reference in their entirety. Should one or more of the incorporated references and similar materials differs from or contradicts this application, including but not limited to defined terms, term usage, described techniques, or the like, this application controls.

As previously stated and as used herein, the singular forms “a,” “an,” and “the,” refer to both the singular as well as plural, unless the context clearly indicates otherwise. The term “comprising” as used herein is synonymous with “including,” “containing,” or “characterized by,” and is inclusive or open-ended and does not exclude additional, unrecited elements or method steps. Although many methods and materials similar or equivalent to those described herein can be used, particular suitable methods and materials are described herein. Unless context indicates otherwise, the recitations of numerical ranges by endpoints include all numbers subsumed within that range. Furthermore, references to “one implementation” are not intended to be interpreted as excluding the existence of additional implementations that also incorporate the recited features. Moreover, unless explicitly stated to the contrary, implementations “comprising” or “having” an element or a plurality of elements having a particular property may include additional elements whether or not they have that property.

The terms “substantially” and “about”, if or when used throughout this specification describe and account for small fluctuations, such as due to variations in processing. For example, these terms can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%, and/or 0%.

Underlined and/or italicized headings and subheadings are used for convenience only, do not limit the disclosed subject matter, and are not referred to in connection with the interpretation of the description of the disclosed subject matter. All structural and functional equivalents to the elements of the various implementations described throughout this disclosure that are known or later come to be known to those of ordinary skill in the art are expressly incorporated herein by reference and intended to be encompassed by the disclosed subject matter. Moreover, nothing disclosed herein is intended to be dedicated to the public regardless of whether such disclosure is explicitly recited in the above description.

Regarding this disclosure, the term “a plurality of” refers to two or more than two. Unless otherwise clearly defined, orientation or positional relations indicated by terms such as “upper” and “lower” are based on the orientation or positional relations as shown in the Figures, only for facilitating description of the disclosed technology and simplifying the description, rather than indicating or implying that the referred devices or elements must be in a particular orientation or constructed or operated in the particular orientation, and therefore they should not be construed as limiting the disclosed technology. The terms “connected”, “mounted”, “fixed”, etc. should be understood in a broad sense. For example, “connected” may be a fixed connection, a detachable connection, or an integral connection, a direct connection, or an indirect connection through an intermediate medium. For an ordinary skilled in the art, the specific meaning of the above terms in the disclosed technology may be understood according to specific circumstances.

There may be many alternate ways to implement the disclosed technology. Various functions and elements described herein may be partitioned differently from those shown without departing from the scope of the disclosed technology. Generic principles defined herein may be applied to other implementations. Different numbers of a given module or unit may be employed, a different type or types of a given module or unit may be employed, a given module or unit may be added, or a given module or unit may be omitted.

The disclosed technology can be described as a process which is depicted as a flowchart, a flow diagram, a data flow diagram, a structure diagram, or a block diagram. Although a flowchart can describe the operations as a sequential process, many of the operations can be performed in parallel or concurrently. In addition, the order of the operations can be re-arranged. A process is terminated when its operations are completed, but could have additional steps not included in the figure. A process can correspond to a method, a function, a procedure, a subroutine, a subprogram, etc. When a process corresponds to a function, its termination corresponds to a return of the function to the calling function or the main function.

It should be appreciated that all combinations of the foregoing concepts and additional concepts discussed in greater detail herein (provided such concepts are not mutually inconsistent) are contemplated as being part of the disclosed technology. In particular, all combinations of claimed subject matter appearing at the end of this disclosure are contemplated as being part of the technology disclosed herein. While the disclosed technology has been illustrated by the description of example implementations, and while the example implementations have been described in certain detail, there is no intention to restrict or in any way limit the scope of the appended claims to such detail. Additional advantages and modifications will readily appear to those skilled in the art. Therefore, the disclosed technology in its broader aspects is not limited to any of the specific details, representative devices and methods, and/or illustrative examples shown and described. Accordingly, departures may be made from such details without departing from the spirit or scope of the general inventive concept.

What is claimed:

1. A system for growing vegetation, the system comprising:
(a) a plurality of zones, each zone operative to hold at least one batch of vegetation and having one or more specific environmental conditions that vary from environmental conditions in other zones;
(b) at least one zone sensor measuring at least one environmental condition in each zone in the plurality of zones;
(c) at least one controller operatively connected to the plurality of zone sensors to receive sensor measurements from the plurality of zone sensors;
(d) a local database comprising at least one computer readable memory and operatively connected to the at least one controller, the local database operative to store sensor measurements from the plurality of zone sensors on the at least one computer readable memory of the local database;
(e) a remote database comprising at least one computer readable memory and operatively connected to the local database, the remote database operative to receive and to store a subset of the sensor measurements stored in the local database in the computer readable memory of the remote database; and
(f) a remote computing device operatively connected to the remote database, the remote computing device operative to:
(i) receive information regarding movements of batches of vegetation through the plurality of zones; and
(ii) using the received information regarding movement of batches of vegetation through the plurality of zones, associate sensor measurements stored in the remote database with each batch of vegetation based on when the batch of vegetation was in zones in the plurality of zones.

2. The system of claim 1, wherein the at least one environmental condition includes temperature, humidity, CO₂, light, nutrient irrigation, and substrate data.

3. The system of claim 1, wherein at least one of the zone sensors includes at least one of a temperature sensor, a humidity sensor, a CO₂ sensor, and a light sensor.

4. The system of claim 1, wherein the at least one controller controls at least one environmental condition in at least one zone of the plurality of zones.

5. The system of claim 4, wherein the at least one controller controls the at least one environmental condition in the at least one zone by controlling equipment associated with the at least one zone.

6. The system of claim 5, wherein the equipment includes at least one of an HVAC system, a humidifier, a light system, a furnace, an air condition unit, an air vent, a fan, a mister, and a CO₂ injector.

7. The system of claim 1, wherein at least one zone of the plurality of zones is a hermitic growth chamber.

8. The system of claim 1, wherein the remote computing device create a timeline of the environmental conditions that one of the batches of vegetation is subjected to as the batch of vegetation moves through the plurality of zones using the sensor measurements and displays the timeline on a display device.

9. A method of tracking a batch of vegetation through a plurality of zones, the method comprising:
(a) creating a batch object, the batch object identifying the batch of vegetation and assigning the new batch object to a first zone from the plurality of zones the batch of vegetation is placed in;
(b) obtaining at least one environmental condition measurement from the first zone and associating the at least one environmental condition measurement from the first zone with the batch object;
(c) obtaining periodic at least one environmental condition measurements from the first zone and associating the obtained periodic at least one environmental conditional measurements with the batch object until a time the batch objected is assigned to a second zone indicating the batch of vegetation has been moved to the second zone; and
(d) obtaining periodic at least one environmental condition measurement from the second zone and associating the at least one environmental condition measurement from the second zone with the batch object.

10. The method of claim 9 further comprising:
(a) obtaining periodic the at least one environmental condition measurements from the second zone and associating the obtained at least one environmental conditional measurements with the batch object until a time the batch object is assigned to a third zone indicating the batch of vegetation has been moved to the third zone; and
(b) obtaining periodic at least one environmental condition measurements from the third zone and associating the obtained at least one environmental condition measurement from the second zone with the batch object.

11. The method of claim 9, wherein the at least one environmental condition comprises at least one of temperature, humidity, CO₂; light, nutrient irrigation, and substrate data.

12. The method of claim 9, wherein the batch object includes an indication of the type of vegetation making up the batch of vegetation indicated in the batch object.

13. The method of claim 9, further comprising creating a timeline of the environmental conditions the batch of vegetation identified in the batch object is subjected to as the batch of vegetation moves through the plurality of zones, using the obtained environmental condition measurements.

14. The method of claim 9, wherein the at least one environmental condition measurement obtained from the first zone is obtained from at least one zone sensor measuring the at least one environmental condition in the first zone, and wherein the at least one environmental condition measurement obtained from the second zone is obtained from at least one zone sensor measuring the at least one environmental condition in the second zone.

15. The method of claim 14 wherein the at least one zone sensor in the first zone and the at least one zone sensor in the second zone comprises at least one of a temperature sensor, a humidity sensor, a CO₂ sensor, and a light sensor.

16. The method of claim 9 wherein the time the batch objected is assigned to a second zone indicating the batch of vegetation has been moved to the second zone is based on information received after the time has passed.
